(19) United States
(12) Patent Application Publication
(10) Pub. No.: US 2026/0225372 A1
(43) Pub. Date: Aug. 6, 2026

(54) RESIDUAL AMOUNT MANAGEMENT DEVICE OUTPUTTING INFORMATION FOR GUIDING SUPPLY OF PRINTING CONSUMABLE INTO TANK

(71) Applicant: BROTHER KOGYO KABUSHIKI KAISHA, Nagoya (JP)

(72) Inventor: Taichiro KIMOTO, Nagoya (JP)

(73) Assignee: BROTHER KOGYO KABUSHIKI KAISHA, Nagoya (JP)

(21) Appl. No.: 19/578,699

(22) Filed: Mar. 25, 2026

Related U.S. Application Data
(63) Continuation of application No. PCT/JP2024/032860, filed on Sep. 13, 2024.

(30) Foreign Application Priority Data
Sep. 28, 2023 (JP) 2023-167556

(51) Int. Cl. B41J 2/175; B41J 29/13; G01F 23/00; G06Q 30/0601

(52) U.S. Cl. CPC B41J 2/17566; B41J 29/13; G01F 23/0007; G06Q 30/0633

(57) ABSTRACT

A residual amount management device obtains printing-amount information indicating a printing amount of a consumed printing consumable. In response to detection that, after determining that the printing consumable is supplied into the tank, the level of the printing consumable in the tank becomes lower than the intermediate reference level, the device determines whether a difference between a current estimated amount and a current detection amount is greater than or equal to a predetermined amount. The current estimated amount is calculated using the printing-amount information. The current estimated amount is calculated in response to determining that the printing consumable is supplied into the tank. The current detection amount is based on detection that the level of the printing consumable becomes lower than the intermediate reference level. In a case where the difference is less than the predetermined amount, the device outputs supply-guidance information for guiding a supply of a printing consumable.

### REFERENCE TO RELATED APPLICATIONS

This is a bypass continuation application of International Application No. PCT/JP2024/032860 filed on September 13, 2024 which claims priority from Japanese Patent Application No. 2023-167556 filed on September 28, 2023. The entire contents of the International Application and the priority application are incorporated herein by reference.

### BACKGROUND ART

A technology is known in which a sensor is provided at a bottom portion of a tank of a printing device, and, based on the detection results of the level of printing consumable by the sensor, the latest residual amount of the printing consumable in the printing device is calculated and managed.

### SUMMARY

In the above known technology, when the printing consumable in the tank is consumed and reduced by printing being performed, the printing consumable in the tank can be replenished by a user supplying the printing consumable from a storage body into the tank.

In the above conventional technology, operations when, for example, the amount of printing consumable that the user supplies into the tank from the storage body is not the entire amount in the storage body are not taken into consideration.

On the other hand, in recent years, a service is known in which a predetermined contract is concluded with the user of the printing device, and based on the contract, the user is charged according to the printing content. Depending on the contracted service, printing consumables may be delivered to the user from a predetermined delivery source according to the consumption of the printing consumable without any financial burden to the user. In this case, if printing is performed without supplying the entire amount of the printing consumable in the storage body and the printing consumable in the tank is consumed as described above, new printing consumables would be delivered even though some printing consumable remains in the storage body, and the service provider will become greatly disadvantaged.

In view of the foregoing, it is an object of the present disclosure to provide a residual amount management device which can restrict a printing consumable being delivered to a user in a state where a printing consumable is remaining in a storage body.

In order to attain the above and other objects, according to one aspect, the present disclosure provides a residual amount management device for managing a residual amount of a printing consumable for a printing device. The printing device includes: a tank configured to store the printing consumable supplied from a storage body having a predetermined capacity for storing a printing consumable; a level sensor configured to detect whether a level of the printing consumable in the tank is higher than or equal to an intermediate reference level, the intermediate reference level corresponding to an intermediate portion of the tank in a vertical direction; and a print engine configured to perform image formation on a printing medium by using the printing consumable in the tank. The residual amount management device is configured to perform: a printing amount obtaining process including: obtaining printing-amount information indicating a printing amount of the printing consumable consumed by image formation using the print engine; a first determining process in response to detection, by the level sensor, that the level of the printing consumable in the tank has increased from below the intermediate reference level to at or above the intermediate reference level, the first determining process including: determining that the printing consumable is supplied into the tank from the storage body; a second determining process in response to detection, by the level sensor, that after the first determining process, the level of the printing consumable in the tank becomes lower than the intermediate reference level during the image formation, the second determining process including: determining whether a difference between a current estimated amount and a current detection amount is greater than or equal to a predetermined amount, the current estimated amount being calculated using the printing-amount information obtained in the printing amount obtaining process, the current estimated amount being calculated in response to determining that the printing consumable is supplied into the tank in the first determining process, the current detection amount being based on detection, by the level sensor, that the level of the printing consumable becomes lower than the intermediate reference level; and a supply guidance process in a case where the difference is determined to be less than the predetermined amount in the second determining process, the supply guidance process including: outputting supply-guidance information for guiding a supply of a printing consumable into the tank.

Accordingly, disadvantages to a service provider can be reduced by restricting delivery of a consumable to a user while the consumable remains in the storage body.

### BRIEF DESCRIPTION OF DRAWINGS

FIG. 1 is a block diagram illustrating an overall functional configuration of a printing process system.

FIG. 2 is a schematic diagram illustrating a configuration of a printer included in the printing process system.

FIGS. 3A-3J are illustrations of a relation between the amount of ink in a tank and the ON/OFF state behavior of a level sensor.

FIG. 4 is an external view illustrating a state where an open/close cover on a housing of the printer is open and ink supply ports of four tanks are exposed to an outside.

FIGS. 5A-5D are illustrations of counting up behavior of a supply counter and a sensor counter.

FIG. 6 is a flowchart illustrating an example of a control procedure performed by the printer.

FIG. 7 is a flowchart illustrating details of a printer initialization process in S100.

FIG. 8 is a flowchart illustrating details of a level sensor checking process in S120.

FIGS. 9A-9D are illustrations of examples of displays.

FIG. 10 is a flowchart illustrating details of an ink consumption process in S200.

FIG. 11 is a flowchart illustrating details of a count incrementation process in S210.

FIGS. 12A-12E are illustrations of examples of displays.

FIG. 13 is a flowchart illustrating details of a dot count correction process in S240.

FIG. 14 is a flowchart illustrating details of a process for a case where the cover is opened and closed in S300.

FIGS. 15A -15B are illustrations of examples of displays.

FIG. 16 is a flowchart illustrating details of an ordering process in S400.

### DESCRIPTION

Hereinafter, an embodiment of the present disclosure will be described while referring to the accompanying drawings.

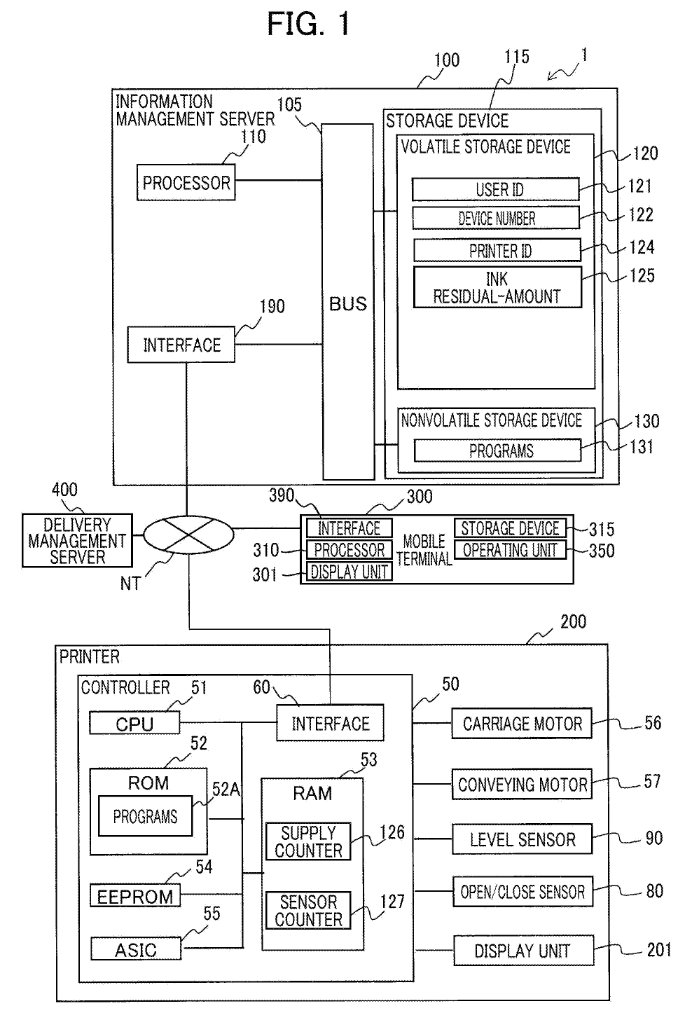

An embodiment of a printing process system of the present disclosure is illustrated in FIG. 1. The present embodiment is an embodiment of a printing process system 1 which provides a print service based on a print contract in which a fee is charged according to the number of prints executed by a printer 200. In the printing process system 1, when a certain amount of printing consumable (described later) used by the printer 200 is consumed, new printing consumables are automatically delivered by a service provider without any financial burden to the user and supplied.

### Overall Configuration of Printing Process System

In FIG. 1, the printing process system 1 includes an information management server 100, the printer 200, a mobile terminal 300, and a delivery management server 400. The information management server 100, the printer 200, the mobile terminal 300, and the delivery management server 400 are connected to a network NT, and are capable of communicating with each other. The printer 200 is an example of the printing device, and is also an example of the residual amount management device.

### Configuration of Printer

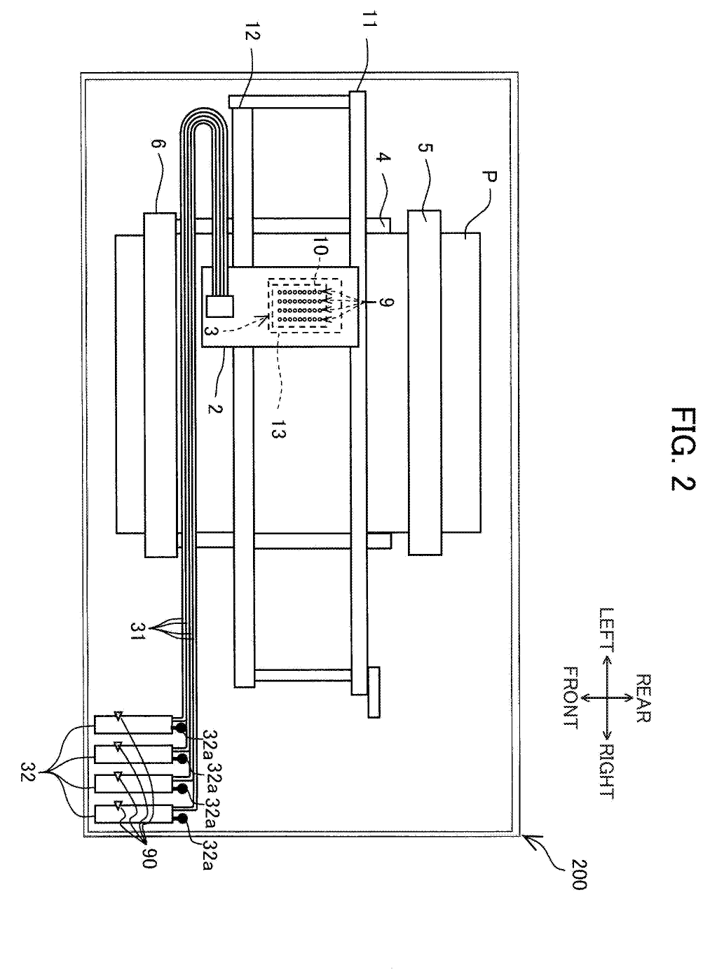

The printer 200 included in the printing process system 1 described above will be described with reference to FIG. 2. As illustrated in FIG. 2, the printer 200 includes a carriage 2, an inkjet head 3, a platen 4, and conveying rollers 5 and 6. The side on which the conveying roller 6 is located is the front side of the printer 200, and the side on which the conveying roller 5 is located is the rear side of the printer 200. Additionally, the direction from the rear side toward the front side is the conveying direction, and the left-right direction is also the main scanning direction.

The carriage 2 is connected to a carriage motor 56 (see FIG. 1) by, for example, a belt, although not shown in the drawings, and moves in the main scanning direction along guide rails 11 and 12 when driven by the carriage motor 56.

The inkjet head 3 is connected to four tubes 31. The four tubes 31 are respectively connected to four tanks 32 included in the right-front end portion of the printer 200 and juxtaposed in the main scanning direction. Ink in the colors black, yellow, cyan, and magenta stored in the corresponding ink tank 32 is supplied to the inkjet head 3 via the tubes 31.

The printer 200 in the present embodiment is, for example, a relatively low-cost model and is used by supplying each tank 32 with ink from a corresponding bottle (not shown). The bottle is an example of the storage body. In other words, a cap 32a is located on each tank 32, and by manually supplying the ink in the bottle in a state where the cap 32a is removed, the tank 32 is filled with the ink. The capacity of the bottle is set to a fixed value, i.e., a predetermined capacity, for example. In the delivery service described above, the bottle is delivered to the user, and by a single supplying operation performed by the user, the entire amount of ink in the bottle can be supplied into the tank 32 on the predetermined capacity basis described above. The ink is an example of the printing consumable.

The inkjet head 3 is mounted to the carriage 2, and image formation, i.e., printing is performed by ink being ejected from the inkjet head 3 while the carriage 2 moves the inkjet head 3 in the main scanning direction. The inkjet head 3 has a channel unit 13. The inkjet head 3 and the carriage 2 are each an example of the printing unit and an example of the print engine.

Four nozzle rows 9, each including a plurality of nozzles 10, are juxtaposed in the main scanning direction in the channel unit 13. The pluralities of nozzles 10 eject ink in the respective colors black, yellow, cyan, and magenta in order from the right side to the left side, for example. A corresponding color of ink is supplied to the plurality of nozzles 10 in each nozzle row 9 via one common tube 31 and one common ink channel. In other words, ink from one tank 32 is supplied through the tube 31, the channel unit 13, and each of the nozzles 10, in that order.

The platen 4 is positioned beneath the inkjet head 3 and faces the nozzle surface during printing. The platen 4 extends across the entire width of a recording sheet P in the main scanning direction for supporting the recording sheet P from below. The recording sheet P is an example of the printing medium. The conveying rollers 5 and 6 are respectively positioned on an upstream side and a downstream side of the platen 4 in the conveying direction. The conveying rollers 5 and 6 are connected to a conveying motor 57 (see FIG. 1) through, for example, gear (not shown), and conveys the recording sheet P in the conveying direction by being rotated by the drive of the conveying motor 57.

The printer 200 having the above configuration performs printing on recording sheets P by moving the carriage 2 in the main scanning direction while ejecting ink from the pluralities of nozzles 10 of the inkjet head 3 each time after the recording sheet P is conveyed at a predetermined distance by the conveying rollers 5 and 6.

### Level Sensor

Each tank 32 includes a level sensor 90 for detecting whether the level of ink inside is higher than or equal to an intermediate reference level corresponding to an intermediate portion of the tank 32 in a vertical direction. The level sensor 90 detects the level of ink according to a well-known technique, and outputs a corresponding detection signal. The detection signal of the level sensor 90 enters an ON state when the liquid level is higher than or equal to the intermediate reference level, and enters an OFF state when the liquid level is below the intermediate reference level.

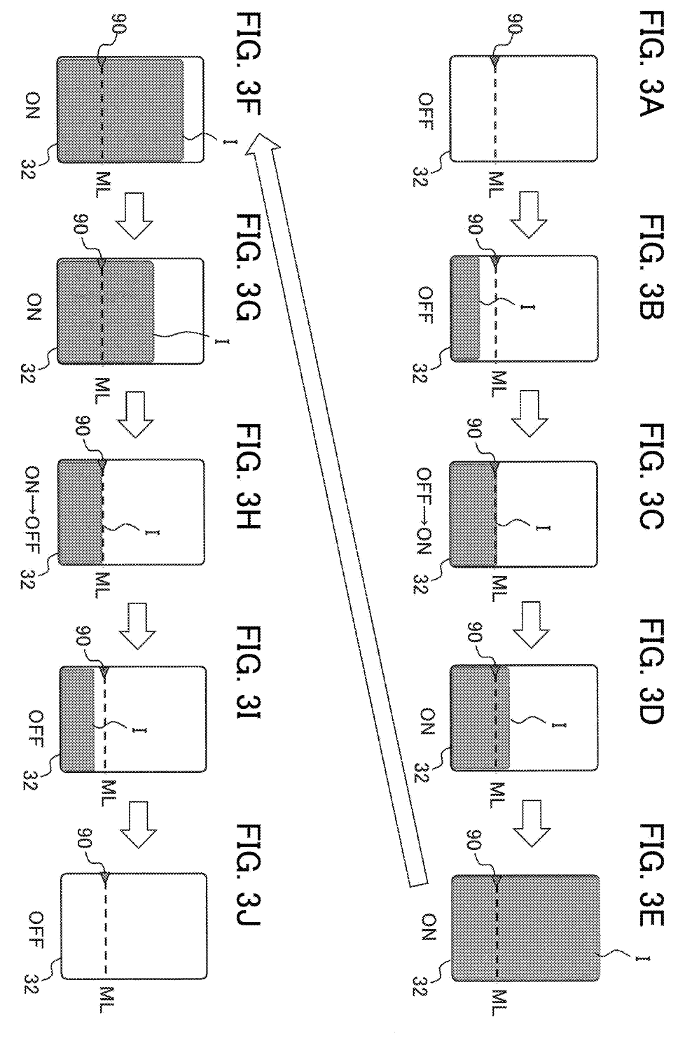

The relation between the amount of ink in the tank 32 and the behavior of the level sensor 90 in the ON/OFF state are illustrated in FIGS. 3A-3J. The black triangles illustrated in the figure represent the level sensor 90 described above, and the presence of ink at an intermediate reference level ML is detected by the level sensor 90. In this example, the distance of the intermediate reference level ML from the bottom surface of the tank 32 is around 1/3 of the height of the tank 32 in the up-down direction.

FIG. 3A illustrates an empty state in which no ink is inside the tank 32, and the level sensor 90 is in the OFF state. FIG. 3B illustrates a state in which ink is supplied from the bottle into the tank 32 and a liquid level I has risen slightly. In this state, since the liquid level I has not yet reached the intermediate reference level ML, the level sensor 90 remains in the OFF state.

FIG. 3C illustrates a state in which ink is further supplied from the state illustrated in FIG. 3B, and the liquid level I has reached the intermediate reference level ML. In this state, the level sensor 90 switches from the OFF state described above to the ON state. FIG. 3D illustrates a state in which ink is further supplied and the liquid level I has risen. FIG. 3E illustrates a state transitioned from the state illustrated in FIG. 3D. In the state illustrated in FIG. 3E the tank 32 is substantially full of ink. Throughout FIGS. 3C to 3E, the level sensor 90 remains in the ON state.

On the other hand, when printing is performed by the inkjet head 3 and ink is consumed, the liquid level I decreases slightly from the state illustrated in FIG. 3E where the ink is full to a state illustrated in FIG. 3F. However, in the state illustrated in FIG. 3F, the level sensor 90 remains in the ON state. FIG. 3G illustrates a state where ink is further consumed and the liquid level I has fallen. In this state, since the liquid level I is still above the intermediate reference level ML, the level sensor 90 remains in the ON state.

FIG. 3H illustrates a state where ink is further consumed from the state illustrated in FIG. 3G, and the liquid level I has fallen below the intermediate reference level ML. In this state, the level sensor 90 switches from the ON state described above to the OFF state. FIG. 3I illustrates a state where ink is further consumed and the liquid level I has fallen. FIG. 3J illustrates a state transitioned from the state illustrated in FIG. 3I. In the state illustrated in FIG. 3J the ink in the tank 32 has been depleted (which means that the available ink has been depleted, where in actuality, some ink may remain in the tank 32). Throughout FIGS. 3H to 3I, the level sensor 90 remains in the OFF state.

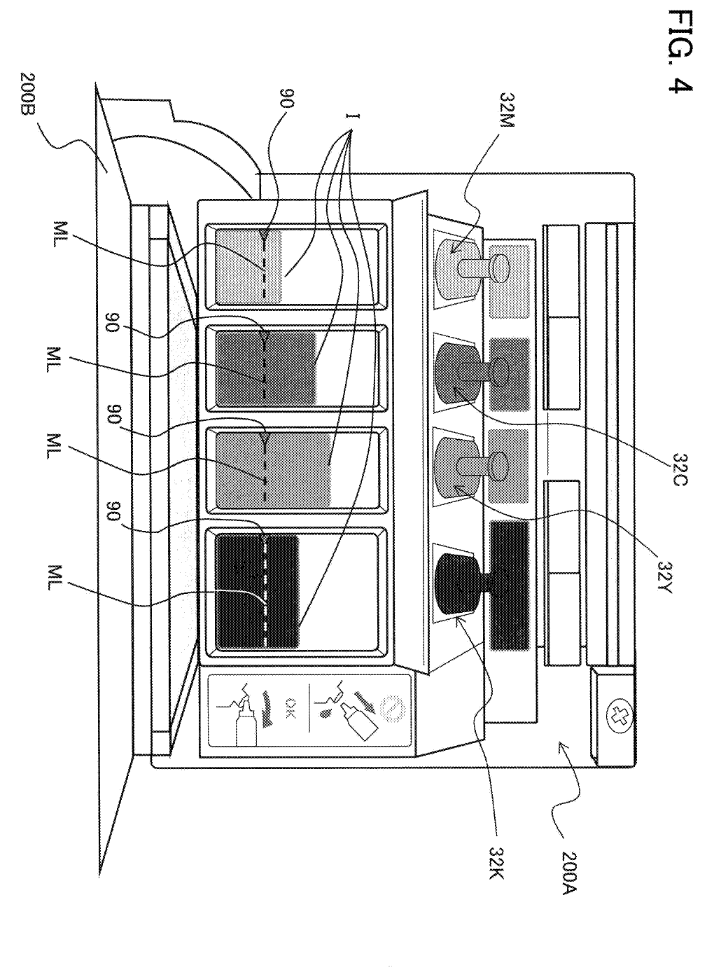

FIG. 4 illustrates the printer 200 in a state where an openable cover 200B located on a housing 200A is open. By opening the openable cover 200B, a supply port (not shown) for the ink of the four tanks 32 described above positioned in the housing 200A can be exposed to an outside. In this example, a magenta tank 32M, a cyan tank 32C, a yellow tank 32Y, and a black tank 32K are arranged in this order from left to right. The level sensor 90 for detecting whether the liquid level I inside the tank has reached the intermediate reference level ML is included in each of the tanks 32M, 32C, 32Y, and 32K.

Note that, while not shown in the drawings, an open/close sensor 80 (see FIG. 1) for detecting the open/closed state of the openable cover 200B according to a well-known technique is located on the housing 200A, for example. The open/close sensor 80 detects whether the openable cover 200B is in the open or closed state, and outputs a corresponding detection signal. The openable cover 200B is an example of the open/close portion.

### Electrical Configuration of Printing Process System 1

Returning to FIG. 1, the electrical configuration of the printing process system 1 will be described.

### Information Management Server

The information management server 100 is a server installed and managed by the service provider, for example, the manufacturer of the printer 200 or the management company of the printing service described above. The information management server 100 has a processor 110, a storage device 115, and an interface 190. The processor 110, the storage device 115, and the interface 190 are interconnected via a bus 105.

The storage device 115 includes a volatile storage device 120 and a nonvolatile storage device 130. The volatile storage device 120 is a DRAM, for example, and has a user ID storage area 121, a device number storage area 122, a printer ID storage area 124, and an ink residual-amount storage area 125. Each piece of information stored in each storage area is used to manage the use of the printing service by corresponding one or more printers and corresponding one or more users. The nonvolatile storage device 130 is a hard disk drive or a solid state drive, for example, and has a program storage area 131.

The processor 110 is a device that performs data processing, such as a CPU. By executing programs stored in the program storage area 131, the processor 110 executes various processes including a process for performing data communications with the mobile terminal 300, the printer 200, and the delivery management server 400 connected to the network NT. The program storage area 131 of the nonvolatile storage device 130, and the processor 110 which uses the program storage area 131 are each an example of the controller.

The interface 190 is a wired LAN interface or a wireless interface for communicating with other devices, and is connected to the network NT.

### Delivery Management Server

The delivery management server 400 is installed at a delivery service company providing a delivery service for delivering various articles including the bottle described above, for example. Although not shown in the drawings, the delivery management server 400 has a processor, a storage device, and an interface for connecting to the network NT.

### Mobile Terminal

The mobile terminal 300 is a smartphone or other mobile device owned by the user, and is connected to the network NT through wireless communication. The mobile terminal 300 has a processor 310, a storage device 315, an interface 390 for connecting to the network NT, a display unit 301, and an operating unit 350. Various programs are stored in the program storage area included in the storage device. Alternatively, other information terminals such as a tablet computer or a personal computer may be used in place of the mobile terminal 300. In the following description, these information terminals will collectively be called simply the “mobile terminal”. The display unit 301 is a display and the operating unit 350 is an operation interface or a user interface to receive an operation inputted by a user.

### Printer

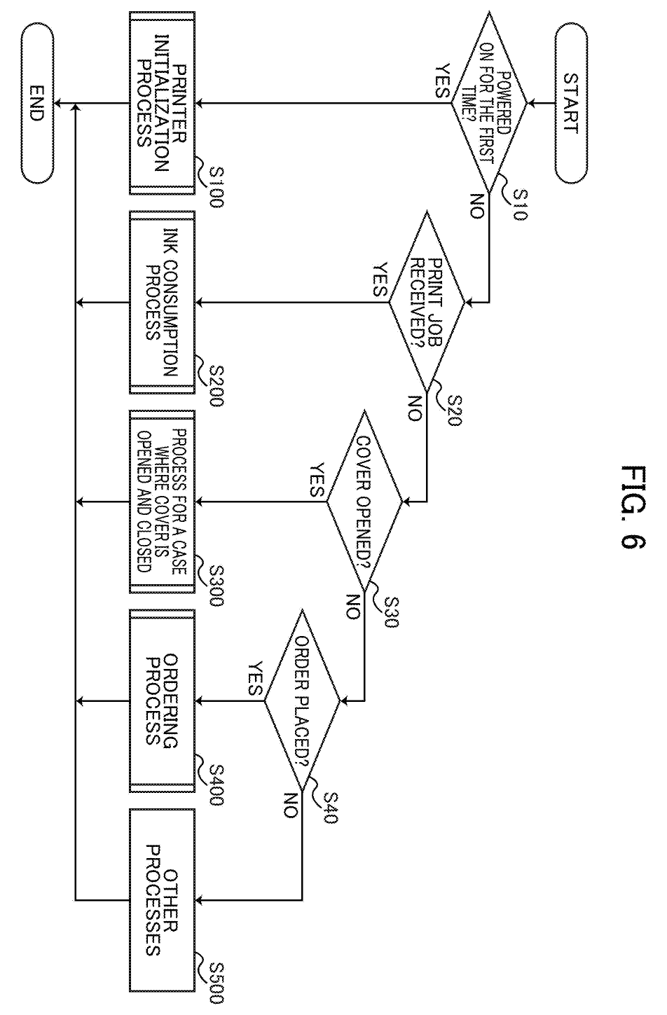

The printer 200 includes a controller 50 for controlling operations of the printer 200, the carriage motor 56, the conveying motor 57, the level sensor 90, the open/close sensor 80, and an appropriate display unit 201. The controller 50 includes a CPU 51, a ROM 52, a RAM 53, an EEPROM 54, an application-specific integrated circuit (ASIC) 55, and an interface 60. A supply counter 126 and a sensor counter 127 are stored in the RAM 53 (described later in greater detail). The supply counter 126 and the sensor counter 127 are backed up to a nonvolatile memory such as the EEPROM 54 so that control can be continued even when the power of the printer 200 is turned off and on. The ROM 52 has a program storage area 52A. Programs stored in the program storage area 52A include programs that execute the processes illustrated in the flowcharts of FIGS. 6-8, 10, 11, 13, 14 and 16 described later. With this configuration, the controller 50 controls the carriage motor 56 and the conveying motor 57, for example. Additionally, detection signals from the level sensor 90 and the open/close sensor 80 described above are inputted into the controller 50. Then, the controller 50 operates as the residual amount management device described later. The display unit 201 is a display.

The interface 60 is a wired LAN interface or a wireless interface for communicating with other devices, and is connected to the network NT described above.

While the configuration in FIG. 1 illustrates a single CPU 51, the controller 50 may include a plurality of CPUs 51, and the plurality of CPUs 51 may share the processing load. Similarly, while a single ASIC 55 is illustrated in FIG. 1, the controller 50 may include a plurality of ASICs 55, and the plurality of ASICs 55 may share the processing load.

### Background of Present Embodiment

As described above, in the printing process system 1 of the present embodiment, when ink in the tank 32 has been consumed, a new bottle is delivered free of charge to the user without any financial burden to the user. The user manually fills the tank 32 with ink by supplying the ink inside the bottle. The entire amount of ink in the bottle can be supplied into the tank 32 by a single supplying operation performed by the user, as described above.

For example, in the state where ink is consumed by printing operations and the tank 32 is empty as illustrated in FIG. 3A, by supplying the entire amount of ink in the bottle into the tank 32, the liquid level I rises in the order of FIGS. 3A, 3B, 3C and 3D. Ultimately, the tank 32 becomes substantially full of ink as illustrated in FIG. 3E. By printing being performed from this state, the ink is consumed, and the liquid level I changes in the order of FIGS. 3E, 3F, 3G, 3H, 3I and 3J. Then, the tank 32 becomes empty, and bottles are delivered again.

However, when the user does not supply the entire amount of ink in the delivered bottle, either intentionally or unintentionally for some reason, the liquid level I rises in the order of FIGS. 3A, 3B and 3C,then stops at FIG. 3D, for example. In this state, when printing is performed and ink is consumed, the liquid level I changes in the order of FIGS. 3D, 3H, 3I and 3J. Hence, in this case, even though ink is remaining in the bottle, a new bottle would be delivered within a short time-frame and the service provider would become greatly disadvantaged.

### Features of Embodiment

A feature of the present embodiment involves avoiding disadvantages to the service provider by restricting of the delivery of a new bottle to the user in a state where ink is remaining in the bottle as described above. Accordingly, the supply counter 126 and the sensor counter 127 described above are stored, for example. In the present embodiment, detection of the user not supplying the entire amount of ink in the bottle into the tank 32 is performed based on the detection results of the level sensor 90 and count values of the supply counter 126 and the sensor counter 127 (described later in greater detail).

### Incremental Behavior

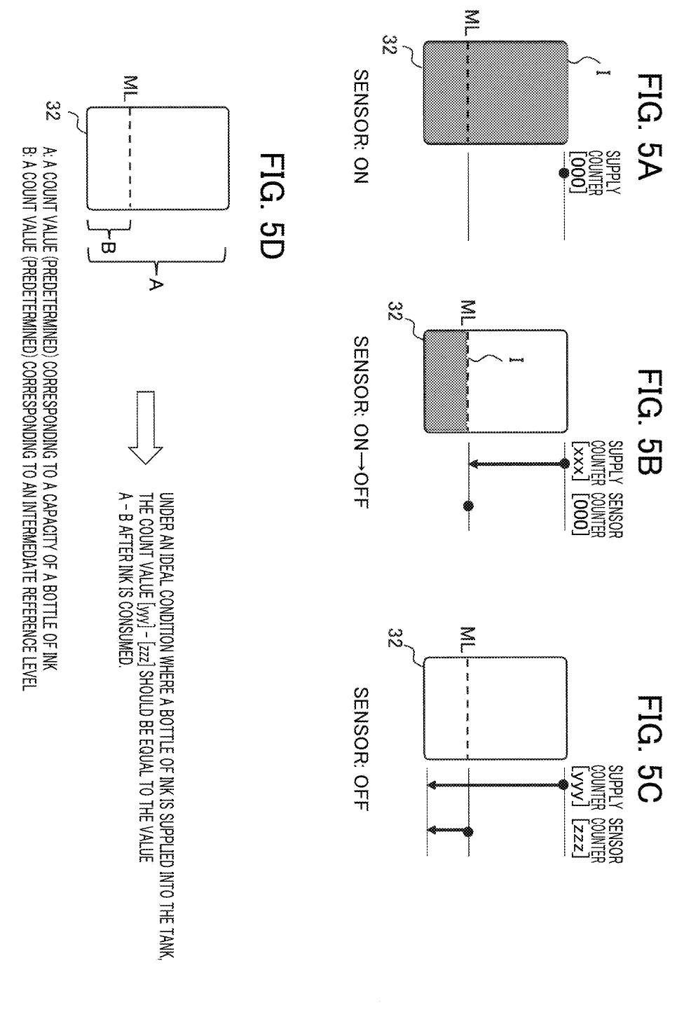

The incremental behavior of the supply counter 126 and the sensor counter 127 are illustrated in FIGS. 5A to 5C.

The supply counter 126 is a counter whose initial value is set to and whose value is incremented as the liquid level I drops. Here, the initial value of the supply counter 126 corresponds to the state where the entire amount of ink is supplied from the bottle into the tank 32 after ink in the tank 32 has been depleted.

The sensor counter 127 is a counter whose initial value is set to and whose value is incremented as the liquid level I drops. Here, the initial value of the sensor counter corresponds to the state where the detection signal of the level sensor 90 has switched from the ON state to the OFF state due to a decrease in the liquid level I in the tank 32 as described above.

When printing is performed, the amount of ink ejected from the plurality of nozzles 10 of the inkjet head 3, which corresponds to the printing amount, is detected according to a well-known technique, and the amount of ink consumed is calculated according to a well-known technique based on the amount of ink ejected and obtained by the controller 50 of the printer 200. Then, a value corresponding to the obtained amount of ink consumed is added to the count values of both the supply counter 126 and the sensor counter 127.

As illustrated in FIG. 5A, after ink is supplied into the tank 32, the count value of the supply counter 126 is incremented from as ink is consumed through printing operations. In this example, as illustrated in FIG. 5B, when the liquid level I falls to the intermediate reference level ML, the count value of the supply counter 126 is increased to [xxx]. At this time, the count value of the sensor counter 127 starts to increment from the initial value .

Then, in this example, as illustrated in FIG. 5C, when ink inside the tank 32 is consumed and runs out, the count value of the supply counter 126 is increased to [yyy], and the count value of the sensor counter 127 is increased to [zzz].

### Principles of Detecting Entire Amount of Ink Not Being Supplied

On the other hand, since the volume of the bottle is predetermined as described above, a supply count value corresponding to the length to the liquid level I in the height direction when the entire amount of ink in one bottle is supplied into the tank 32, as illustrated in FIG. 5D, is known by design. Therefore, assuming an ideal state where the entire amount of ink in the bottle is supplied after the ink in the tank 32 has been depleted, the count value [xxx] (= [yyy] - [zzz]) of the supply counter 126 should be equal to a value A - B when the liquid level I falls to the intermediate reference level ML illustrated in FIG. 5B described above, in other words, when the detection signal of the level sensor 90 switches from the ON state to the OFF state,. If the entire amount of ink in the bottle is not supplied, the count value of the supply counter 126 would be less than [xxx] when the level sensor 90 switches from the ON state to the OFF state. In the present embodiment, according to the principles described above, it is determined whether the user has supplied the entire amount of ink in the bottle into the tank 32.

### Control Procedure

Next, an example of a control procedure executed by the controller 50 of the printer 200 for achieving the method described above will be described with reference to the flowchart illustrated in FIG. 6.

### Main Flow

In the main flow illustrated in FIG. 6, first in S10 the controller 50 determines whether the printer 200 has been powered on for the first time. When the printer 200 has not been powered on for the first time (S10: NO), the controller 50 advances to S20 described later. When the printer 200 has been powered on for the first time (S10: YES), in S100 the controller 50 executes a printer initialization process (described later in greater detail), then ends the process in FIG. 6.

In S20 the controller 50 determines whether a print job has been received from the mobile terminal 300. When a print job has not been received from the mobile terminal 300 (S20: NO), the controller 50 advances to S30 described later. When a print job has been received from the mobile terminal 300 (S20: YES), in S200 the controller 50 executes an ink consumption process (described later in greater detail), then ends the process in FIG. 6.

In S30 the controller 50 determines whether the openable cover 200B has been opened, based on the results of the open/close sensor 80 of the printer 200. When the openable cover 200B has not been opened (S30: NO), the controller 50 advances to S40 described later. When the openable cover 200B has been opened (S30: YES), in S300 the controller 50 executes a process for a case where the cover is opened and closed (described later in greater detail), then the process in FIG. 6 ends.

In S40 the controller 50 determines whether an order for new ink, that is, a new bottle has been placed from the mobile terminal 300 or from an appropriate operating unit (operating interface) (not shown) of the printer 200. When no order has been placed (S40: NO), the controller 50 advances to S500 described later. When an order has been placed (S40: YES), in S400 the controller 50 executes an ordering process (described later in greater detail), then the process in FIG. 6 ends.

In S500 the controller 50 executes other processes which do not correspond to the processes in S100, S200, S300, or S400, then ends the process in FIG. 6.

### Printer Initialization Process

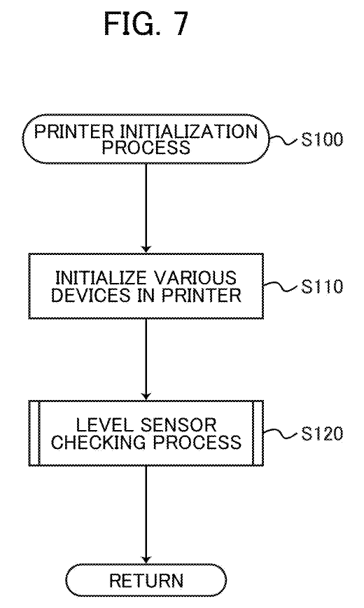

Details of the printer initialization process of S100 are illustrated in FIG. 7. First, in S110 of FIG. 7 the controller 50 executes a predetermined initialization process for the various operating devices, display devices, and other devices of the printer 200. Then, in S120 the controller 50 executes a level sensor checking process and ends the routine in FIG. 7. The level sensor checking process in S120 is included in the printer initialization process of S100 since there may be a case where ink is supplied into the tank 32 when the power is OFF, depending on the user.

### Level Sensor Checking Process

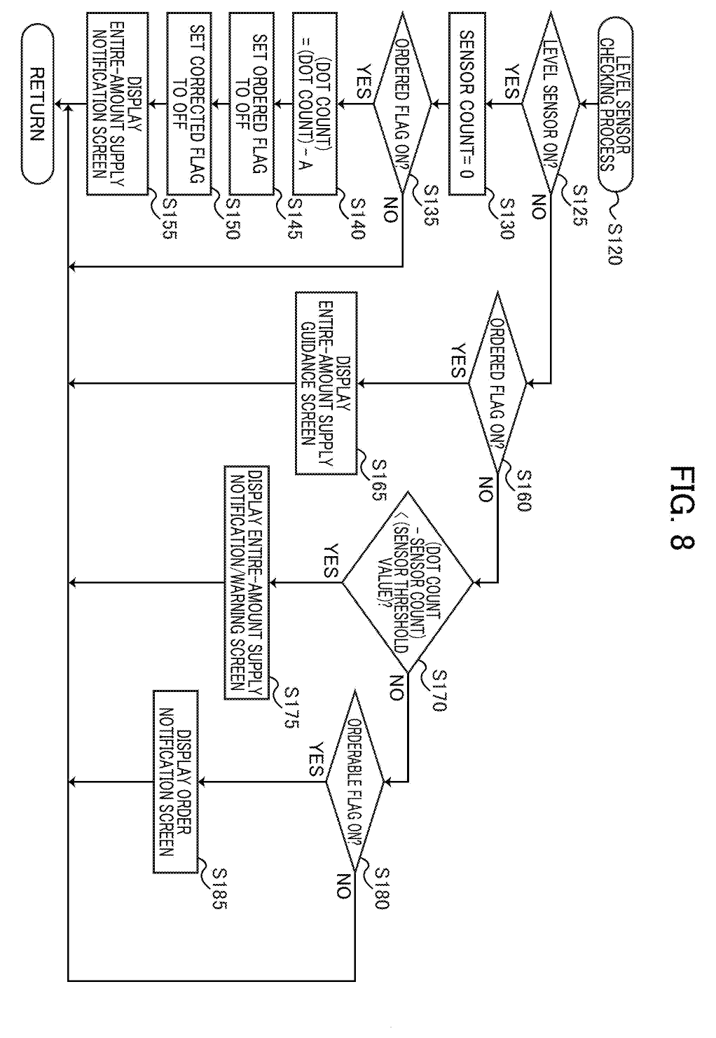

Details of the level sensor checking process in S120 are illustrated in FIG. 8. First, in S125 the controller 50 determines whether the level sensor 90 is in the ON state. In other words, the controller 50 determines whether the liquid level I inside the tank 32 is at a position equal to or higher than the intermediate reference level ML. When the level sensor 90 is in the OFF state, i.e., when the liquid level I is at a position lower than the intermediate reference level ML (S125: NO), the controller 50 advances to S160 described later. When the level sensor 90 is in the ON state, i.e., when the liquid level I is at a position equal to or higher than the intermediate reference level ML (S125: YES), the controller 50 advances to S130. The process executed in S125 is an example of steps in the first determining process.

In S130 the controller 50 resets the count value of the sensor counter 127 (hereinafter referred to as “sensor count”) to zero. Hereinafter, the count value of the sensor counter 127 will be referred to as “sensor count”, and this notation is used in the figures. In S135 the controller 50 determines whether an ordered flag indicating that an order of the bottle of ink has been placed is set to “ON”. When the ordered flag is set to “OFF” (S135: NO), the controller 50 ends the routine in FIG. 8. When the ordered flag is set to “ON” (S135: YES), the controller 50 advances to S140 described later. In a case where, when the power is turned ON, the level sensor 90 is in the ON state and the ordered flag is set to “ON”, it is assumed that the ordered bottle has been delivered to the user and ink has been supplied into the tank 32 while power is OFF.

In S140 the controller 50 subtracts a count value A corresponding to one bottle of ink described above from the count value of the supply counter 126 at this timing. Hereinafter, the count value of the supply counter 126 will be referred to as “dot count” and this notation is used in the figures. This treatment is based on an assumption that the entire amount of ink in one bottle has been supplied into the tank 32. The process executed in S140 is an example of the initialization process. In S145 the controller 50 sets the ordered flag described above to “OFF”.

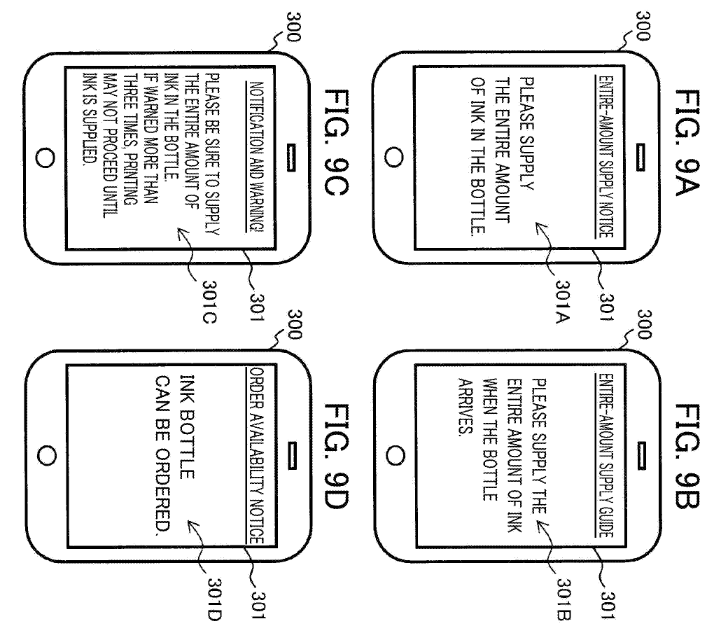

In S150 the controller 50 sets a corrected flag to “OFF”. The corrected flag indicates that corrections in a dot count correction process described later have executed. In S155 the controller 50 displays an entire-amount supply notification screen on the display unit 301 of the mobile terminal 300 or the display unit 201 of the printer 200 described above. The entire-amount supply notification screen is for requesting a supply of an entire amount of ink. For example, display data can be displayed on the display unit 301 of the mobile terminal 300 by mounting an embedded web server (EWS) on the printer 200 and sending the display data to a browser of the mobile terminal 300. A sample display is illustrated in FIG. 9A. Although it is conceivable that the supply of ink has been completed when power is turned ON, this display prompts a user that has not supplied an entire amount of ink. As illustrated in FIG. 9A, an entire-amount supply notification screen 301A including a message “Please supply the entire amount of ink in the bottle.” is displayed on the display unit 301 of the mobile terminal 300. After executing S155, the controller 50 ends the routine in FIG. 8.

In S160 the controller 50 determines whether the ordered flag described above is set to “ON”. When the ordered flag is set to “OFF” (S160: NO), the controller 50 advances to S170 described later. When the ordered flag is set to “ON” (S160: YES), the controller 50 advances to S165. In a case where, when the power is turned ON, the level sensor 90 is in the OFF state and the ordered flag is set to “ON”, it is assumed that the ink in the ordered bottle has yet to be supplied.

In S165 the controller 50 displays the entire-amount supply guidance screen on the display unit 301 of the mobile terminal 300 or the display unit 201 of the printer 200. The entire-amount supply guidance screen is for prompting a supply of an entire amount of ink. A sample display is illustrated in FIG. 9B. As illustrated in FIG. 9B, in this example, an entire-amount supply guidance screen 301B including a message “Please supply the entire amount of ink when the bottle has been delivered.” is displayed on the display unit 301 of the mobile terminal 300. The process executed in S165 is an example of the entire-amount supply guidance process. After executing S165, the controller 50 ends the routine in FIG. 8.

In S170 the controller 50 determines whether the value obtained by subtracting the sensor count from the dot count of the supply counter 126 described above is less than a sensor threshold value. Accordingly, the controller 50 determines whether the entire amount of ink has been supplied. The sensor threshold value corresponds to the intermediate reference level ML where the level sensor 90 switches from the ON state to the OFF state, and is a value obtained by subtracting a margin from the count value A - B. The dot count is merely a count by software, and even with the same dot count, there will be variations in the actual amount of ink consumed. This variation occurs due to individual differences of the printer, printing environments such as temperature, and whether print images are characters or images. The value of the margin is set so as to reduce erroneous detection even if there is such variation. Even when ink is consumed through printing following the level sensor 90 switching from the ON state to the OFF state for example, the value obtained by subtracting the sensor count from the dot count remains unchanged from the value obtained when the level sensor 90 has switched from the ON state to the OFF state. For this reason, the value obtained by subtracting the sensor count from the dot count is used. Accordingly, the determination as to whether an entire amount of ink has been supplied even after the level sensor 90 has switched from the ON state to the OFF state can be performed. When the value is greater than or equal to the sensor threshold value (S170: NO), the controller 50 advances to S180 described later. When the value is less than the sensor threshold value (S170: YES), the controller 50 advances to S175.

In S175 the controller 50 displays an entire-amount supply notification/warning screen on the display unit 301 of the mobile terminal 300 or the display unit 201 of the printer 200. The entire-amount supply notification/warning screen is for requesting a supply of an entire amount of ink as well as issuing a warning. A sample display is illustrated in FIG. 9C. As illustrated in FIG. 9C, in this example, an entire-amount supply notification/warning screen 301C including messages “Please be sure to supply the entire amount of ink in the bottle.” and “If warned more than three times, printing cannot be performed without supplying the ink.” is displayed on the display unit 301 of the mobile terminal 300. After executing S175, the controller 50 ends the routine in FIG. 8.

In S180 the controller 50 determines whether an orderable flag indicating that an order of the bottle of ink can been placed is set to “ON”. When the orderable flag is set to “OFF” (S180: NO), the controller 50 ends the routine in FIG. 8. When the orderable flag is set to “ON” (S180: YES), the controller 50 advances to S185.

In S185 the controller 50 displays an order availability notification screen on the display unit 301 of the mobile terminal 300 or the display unit 201 of the printer 200. The order availability notification screen is for notifying that an order by the user can be placed. A sample display is illustrated in FIG. 9D. As illustrated in FIG. 9D, in this example, a message “Ink can be ordered.” is included in an order availability notification screen 301D on the display unit 301 of the mobile terminal 300. After executing S185, the controller 50 ends the routine in FIG. 8.

### Ink Consumption Process

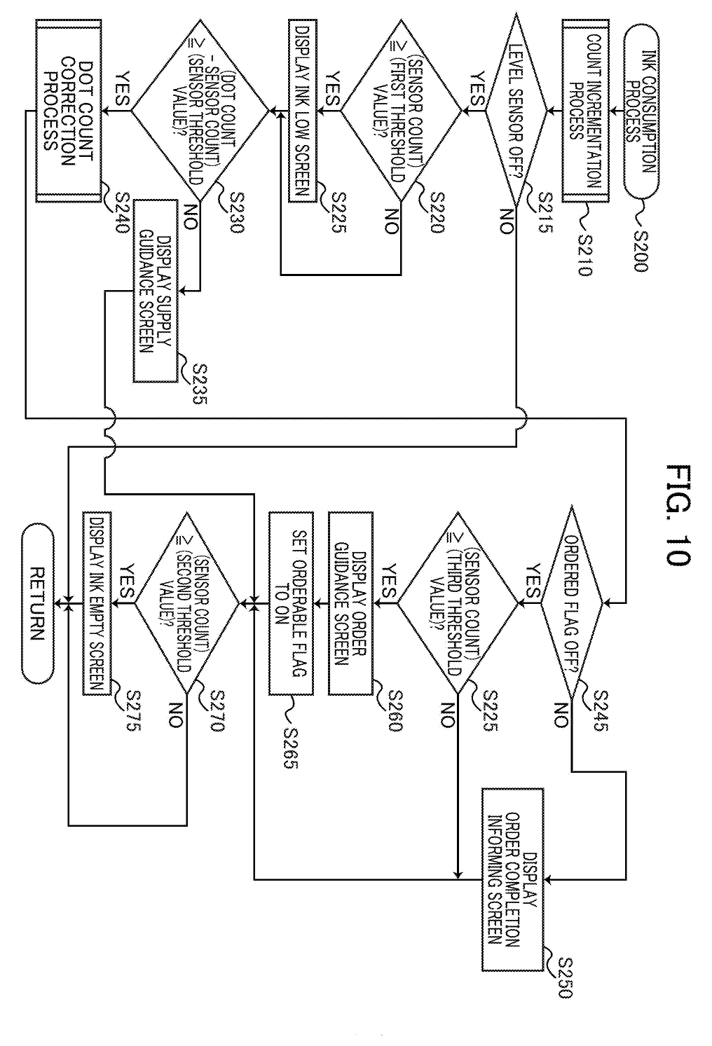

Details of the ink consumption process in S200 are illustrated in FIG. 10. First, in S210 of FIG. 10 the controller 50 executes a count incrementation process.

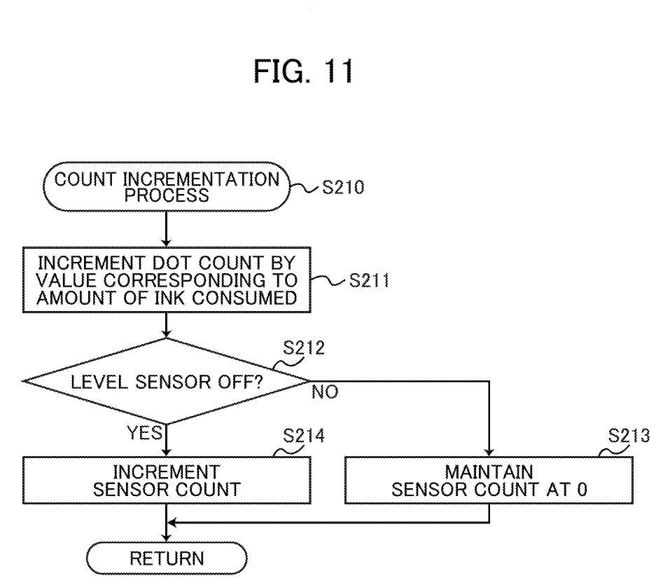

Details of the count incrementation process in S210 are illustrated in FIG. 11. First, in S211 the controller 50 obtains the amount of ink consumed based on the amount of ink ejected from the inkjet head 3, and adds a count value corresponding to the amount of ink consumed to the dot count of the supply counter 126. The process executed in S211 is an example of the printing amount obtaining process, and the obtained amount of ink consumed is an example of the printing-amount information.

In S212 the controller 50 determines whether the level sensor 90 is in the OFF state. When the level sensor 90 is in the ON state (S212: NO), in S213 the controller 50 maintains the sensor count of the sensor counter 127 at zero, and ends the routine in FIG. 11. When the level sensor 90 is in the OFF state, (S212: YES), the controller 50 advances to S214, adds the same count value used in S211 to the sensor count of the sensor counter 127, and ends the routine in FIG. 11.

Returning to FIG. 10, in S215 the controller 50 determines whether the level sensor 90 is in the OFF state. When the level sensor 90 is in the ON state (S215: NO), the controller 50 end the routine in FIG. 10. When the level sensor 90 is in the OFF state, (S215: YES), the controller 50 advances to S220.

In S220 the controller 50 determines whether the sensor count of the sensor counter 127 is greater than or equal to a first threshold value. The first threshold value is set to a predetermined threshold value that corresponds to a case where the ink in the tank 32 has decreased and has nearly been depleted. When the sensor count of the sensor counter 127 is less than the first threshold value (S220: NO), the controller 50 advances to S230 described later. When that the sensor count of the sensor counter 127 is greater than or equal to the first threshold value (S220: YES), the controller 50 advances to S225.

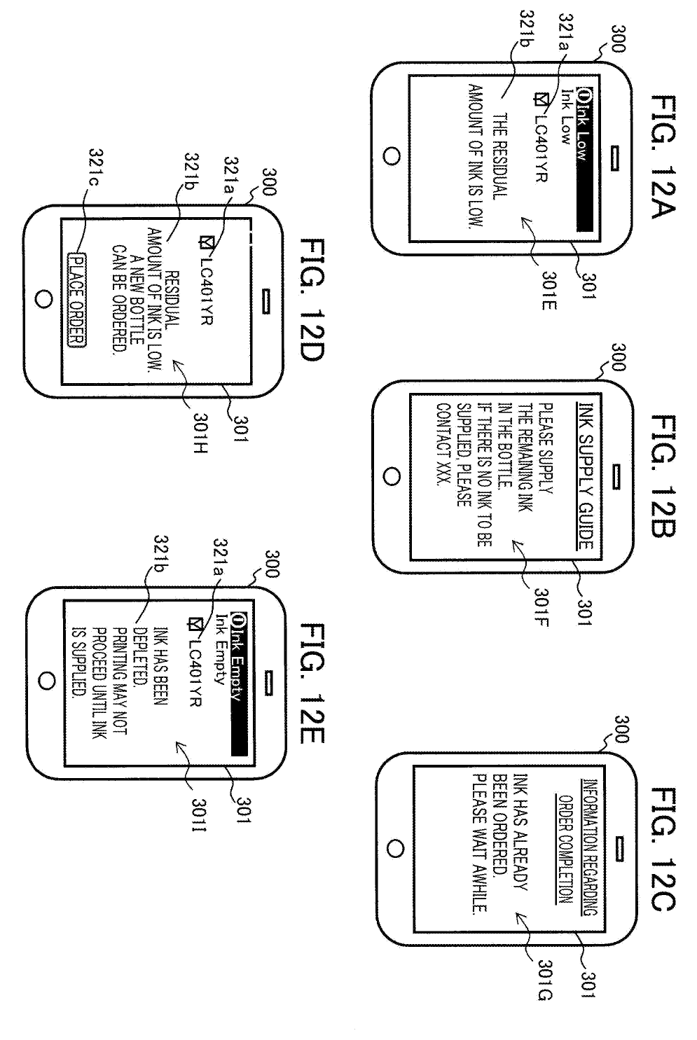

In S225 the controller 50 displays an Ink Low screen on the display unit 301 of the mobile terminal 300 or the display unit 201 of the printer 200. The Ink Low screen indicates that the residual amount of ink is low. A sample display is illustrated in FIG. 12A. In this example, an Ink Low screen 301E includes an ink display part 321a displaying the color of ink for which the residual amount is low, and a message display part 321b displaying “The residual amount of ink is low.” The displayed message is an example of the first residual amount information, and the process executed in S225 is an example of the first residual amount outputting process.

Returning to FIG. 10, in S230 the controller 50 determines whether the value obtained by subtracting the sensor count of the sensor counter 127 from the dot count of the supply counter 126 is greater than or equal to the sensor threshold value described above. Here, the obtained value in this subtracting calculation is equivalent to the dot count value of the supply counter 126 when the level sensor 90 switches from the ON state to the OFF state, and remains constant until ink is to be supplied and the level sensor 90 is to be in the ON state. When the obtained value is greater than or equal to the sensor threshold value (S230: YES), the controller 50 advances to S240 described later. When the obtained value is less than the sensor threshold value (S230: NO), the controller 50 advances to S235. The process executed in S230 is an example of the second determining process.

In S235 the controller 50 displays a supply guidance screen on the display unit 301 of the mobile terminal 300 or the display unit 201 of the printer 200. The supply guidance screen is for guiding the supply of the entire amount of ink in the bottle. A sample display is illustrated in FIG. 12B. As illustrated in the FIG. 12B, in this example, a supply guidance screen 301F including messages “Please supply the remaining ink in the bottle.” and “If there is no ink to be supplied, please contact XXX” are displayed. The process executed in S235 is an example of the supply guidance process, and is also an example of the supply-failure-case guidance process. The message “Please supply the remaining ink in the bottle.” is an example of the supply guiding information, and the message “If there is no ink to be supplied, please contact XXX” is an example of the supply-failure-case guidance information. Note that the process in S235 is repeatedly executed when printing is performed. However, the next display may be done when the sensor count value has increased by a predetermined amount from the previous display. As a result, the supply guidance screen 301F is displayed each time a predetermined amount of printing has been performed. Additionally, in the displaying process of S235 performed for a third time and subsequent times, the controller 50 may display the entire-amount supply notification/warning screen 301C illustrated in FIG. 9C including the messages “Please be sure to supply the entire amount of ink in the bottle.” and “If warned more than three times, printing cannot be performed without supplying the ink.”, instead of the supply guidance screen 301F. Furthermore, printing may be disabled when the warning of the entire-amount supply notification/warning screen 301C is displayed three times. After executing S235, the controller 50 advances to S270 described later.

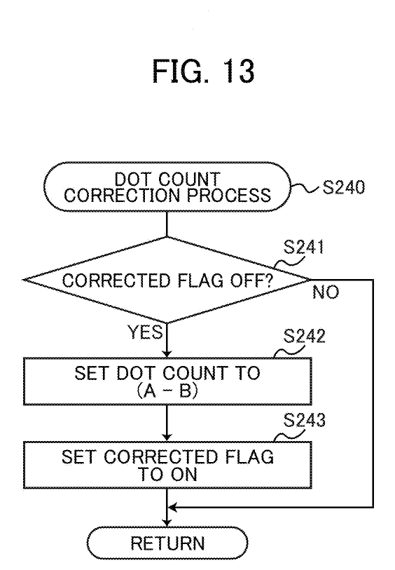

In S240 the controller 50 executes the dot count correction process. Details of the dot count correction process are illustrated in FIG. 13. The dot count is corrected since, as described above, there is variation between the dot count and the actual amount of ink consumed, and by setting the dot count to a predetermined value when the level sensor 90 is in the OFF state, this variation can be absorbed.

First, in S241 the controller 50 determines whether the corrected flag described above is set to “OFF”. When the corrected flag is set to “ON” (S241: NO), the controller 50 ends the routine in FIG. 13 ends. When the corrected flag is set to “OFF” (S241: YES), the controller 50 advances to S242.

In S242 the controller 50 corrects the dot count of the supply counter 126 to the value A - B. The process executed in S242 is an example of the correction process.

In S243 the controller 50 sets the corrected flag to “ON”. Thereafter, the controller 50 ends the routine in FIG. 13, and advances to S245 in FIG. 10.

In S245 the controller 50 determines whether the ordered flag described above is set to “OFF”. When the ordered flag is set to “OFF” (S245: YES), the controller 50 advances to S255 described later. When the ordered flag is set to “ON” (S245: NO), the controller 50 advances to S250.

In S250 the controller 50 displays an order completion informing screen on the display unit 301 of the mobile terminal 300 or the display unit 201 of the printer 200. The order completion informing screen indicates that the bottle has already been ordered. A sample display is illustrated in FIG. 12C. As illustrated in FIG. 12C, in this example, an order completion informing screen 301G including a message “Ink has already been ordered. Please wait awhile.” is displayed. After executing S250, the controller 50 advances to S270 described later.

In S255 the controller 50 determines whether the sensor count of the sensor counter 127 is greater than or equal to a third threshold value. The third threshold value is a predetermined threshold value used to determine whether ordering of the bottle is to be enabled for the user. Note that the third threshold value may have the same value as the first threshold value described above. When that the sensor count is less than the third threshold value (S255: NO), the controller 50 advances to S270 described later. When the sensor count is greater than or equal to the third threshold value (S255: YES), the controller 50 advances to S260.

In S260 the controller 50 displays an order guidance screen on the display unit 301 of the mobile terminal 300 or the display unit 201 of the printer 200. The order guidance screen indicates that the residual amount of ink is low and ordering of the bottle is enabled. A sample display is illustrated in FIG. 12D. In this example, an order guidance screen 301H includes the ink display part 321a similar to the Ink Low screen 301E described above, the message display part 321b displaying “Residual amount of ink is low. A new bottle can be ordered.”, and a button 321c displaying “Place order.” The message displayed on the message display part 321b is an example of the order guidance information, and the process executed in S260 is an example of the order guidance outputting process. By the “Place order” button 321c of the order guidance screen 301H being operated, a corresponding order instruction signal is sent to the delivery management server 400, and an order for the bottle is placed. In S265 the controller 50 sets the orderable flag to “ON”.

In S270 the controller 50 determines whether the sensor count of the sensor counter 127 is greater than or equal to a second threshold value. The second threshold value is a predetermined threshold value corresponding to an empty state where the ink inside the tank 32 has been depleted. When the sensor count is less than the second threshold value (S270: NO), the controller 50 ends the routine in FIG. 10. When the sensor count is greater than or equal to the second threshold value (S270: YES), the controller 50 advances to S275.

In S275 the controller 50 displays an Ink Empty screen on the display unit 301 of the mobile terminal 300 or the display unit 201 of the printer 200. The Ink Empty screen indicates that the residual of ink has been depleted. A sample display is illustrated in FIG. 12E. In this example, an Ink Empty screen 301I includes the ink display part 321a displaying the color of ink which has been depleted, and the message display part 321b displaying “Ink has been depleted. Printing may not proceed until ink is supplied.” The message displayed is an example of the second residual amount information, and the process executed in S275 is an example of the second residual amount outputting process. After executing S275, the controller 50 ends the routine in FIG. 10.

### Process for a case where Cover is Opened and Closed

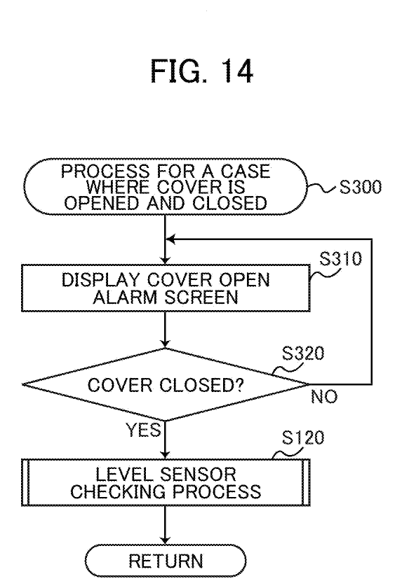

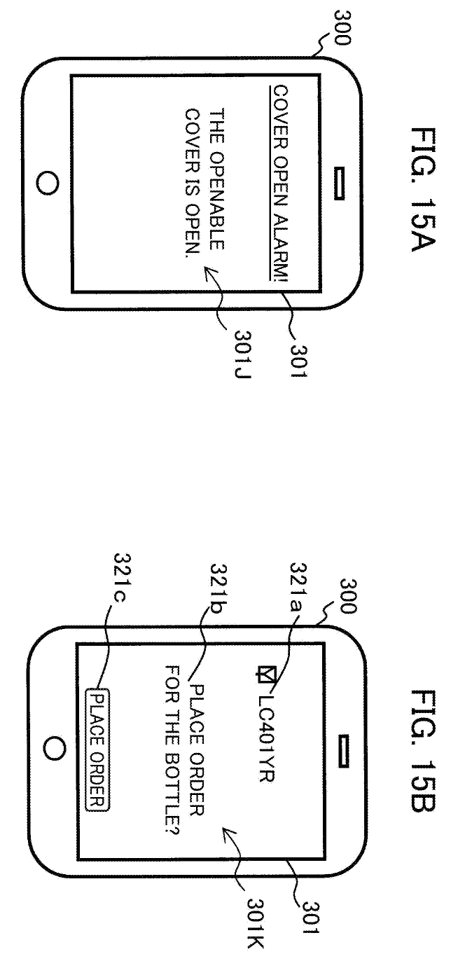

Details of the process for the case where the cover is opened and closed in S300 are illustrated in FIG. 14. First, in S310 the controller 50 displays a cover open alarm screen on the display unit 301 of the mobile terminal 300 or the display unit 201 of the printer 200. The cover open alarm screen indicates that the openable cover 200B is open. A sample display is illustrated in FIG. 15A. In this example, a cover open alarm screen 301J including a message “The openable cover is open.” is displayed.

In S320 the controller 50 determines whether the openable cover 200B has been closed based on the detection results of the open/close sensor 80. When the openable cover 200B has not been closed (S320: NO), the controller 50 returns to S310. When the openable cover 200B has been closed (S320: YES), the controller 50 executes the level sensor checking process in S120 described above and ends the routine in FIG. 14.

### Ordering Process

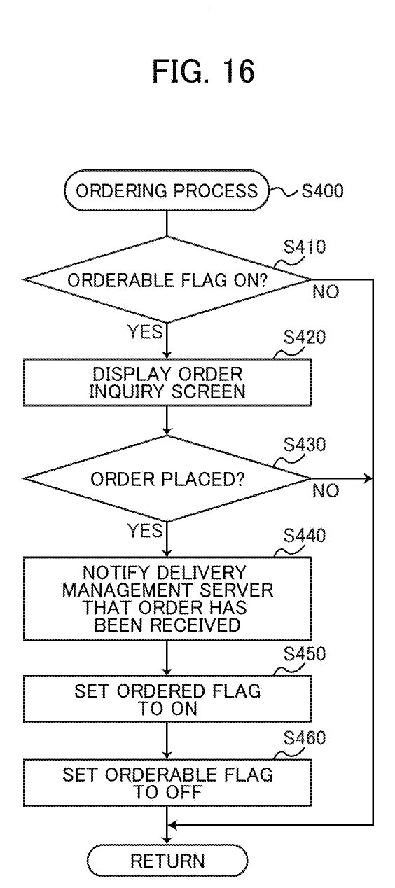

Details of the ordering process in S400 are illustrated in FIG. 16. First, in S410 the controller 50 determines whether the orderable flag described above is set to “ON”. When the orderable flag is set to “OFF” (S410: NO), the controller 50 ends the routine in FIG. 16. When the orderable flag is set to “ON” (S410: YES), the controller 50 advances to S420.

In S420 the controller 50 displays an order inquiry screen on the display unit 301 of the mobile terminal 300 or the display unit 201 of the printer 200. A sample display is illustrated in FIG. 15B. In this example, an order inquiry screen 301K includes the ink display part 321a similar to the Ink Low screen 301E and the order guidance screen 301H described above, the message display part 321b displaying “Place order for the bottle?”, and the button 321c displaying “Place order.” A corresponding order instruction signal is sent to the delivery management server 400 by the “Place order.” button 321c of the order guidance screen 301K being operated, and an order for the bottle is placed (refer to S430 and S440 described later).

In S430 the controller 50 determines whether the “Place order.” button 321c described above has been pressed and an order placement has been instructed. When an order placement has not been instructed (S430: NO), the controller 50 ends the routine in FIG. 16. When an order placement has been instructed (S430: YES), the controller 50 advances to S440.

In S440 the controller 50 notifies the delivery management server 400 that an order placed by the user has been received. In S450 the controller 50 sets the ordered flag to “ON”. In S460 the controller 50 sets the orderable flag to “OFF”, and ends the routine in FIG. 16. Note that the controller 50 may, instead of sending directly to the delivery management server 400, send the order instruction signal temporarily to the information management server100, then have the information management server 100 compile one or more signals and issue a delivery instruction for corresponding bottles to the delivery management server 400.

### Effects of Embodiment

According to the present embodiment described above, the printer 200 includes the level sensor 90 capable of detecting the level of ink inside the tank 32. In response to detecting that the level of ink in the tank 32 has increased from below the intermediate reference level ML to at or above the intermediate reference level ML, the controller 50 of the printer 200 executes S125 (see FIG. 8) to determine that ink has been supplied into the tank 32 from the bottle.

When image forming is performed by the inkjet head 3, the liquid level of ink drops due to ink in the tank 32 being consumed. The amount of ink consumed during the image forming, for example, the dot count of the ink, is obtained by the printer 200 executing S211 (see FIG. 11).

In the present embodiment, in an ideal situation where the entire amount of ink in the bottle has been supplied into the tank 32 by the user, a current estimated amount is obtained based on the supply counter 126, which is calculated using the value of the amount of ink consumed obtained in S211 (see FIG. 11). On the other hand, when the ink level in the tank 32 detected by the level sensor 90 falls below the intermediate reference level ML described above, the current detection amount, that is, the value B in FIG. 5, is obtained.

In S230 (see FIG. 10) the controller 50 of the printer 200 determines whether the difference between the dot count value of the supply counter 126 and the sensor count of the sensor counter 127 is greater than or equal to the sensor threshold value, i.e., the value obtained by subtracting a margin from the value A – B in FIG. 5. In other words, the controller 50 determines whether the difference between the current estimated amount (the dot count value of the supply counter 126) described above and the current detection amount (the sensor count of the sensor counter 127) is greater than or equal to a predetermined value. When the difference is greater than or equal to the predetermined value, it is assumed that the ideal situation described above, that is, the entire amount of ink in the bottle has been supplied into the tank 32 by the user, has been met.

When the difference is less than the predetermined value (S230: NO), it is assumed that the entire amount of ink has not been supplied into the tank 32 by the user, and the printer 200 executes S235 (see FIG. 10). In S235 the controller 50 displays the message “Please supply the remaining ink in the bottle.” for guiding the supply of ink into the tank 32 (see FIG. 12B). Accordingly, this enables the user to be requested to supply the ink remaining in the bottle into the tank 32, thereby avoiding disadvantages to the service provider by restricting the delivery of ink to the user in the ink remaining situation.

As described above, as an exceptional situation, in S230 (see FIG. 10) the controller 50 determines that the difference is less than the predetermined value due to an operational error by the user occurring while supplying ink from a bottle, such as a failure in supplying a portion of the ink by spilling. In the embodiment, in S235 (see FIG. 10) the printer 200 displays the message “If there is no ink to be supplied, please contact XXX” (see FIG. 12B) while also taking into consideration the situation described above. As a result, it is possible to protect users having no malicious intent.

According to the embodiment, when it is determined in S230 (see FIG. 10) that the difference described above is less than the predetermined value, the controller 50 continually repeats S235 at a prescribed timing after the level of ink falls below the intermediate reference level ML. Accordingly, the supply of the remaining amount of ink into the tank 32 can be reliably requested to the user.

According to the embodiment, the first threshold value of the amount of ink consumed is set to correspond to a case where the ink in the tank 32 has decreased and has nearly been depleted. After the level of ink falls below the intermediate reference level ML described above, when ink is consumed and the value of the amount of ink consumed reaches the first threshold value, in S225 (see FIG. 10) the printer 200 displays the message “Residual amount of ink is low.” (see FIG. 12A). As a result, the user can be notified that the residual amount of ink has become low.

According to the embodiment, the second threshold value of the amount of ink consumed is set to correspond to the empty state where the ink inside the tank 32 has been depleted. When ink is consumed and the value of the amount of ink consumed reaches the second threshold value, in S275 (see FIG. 10) the printer 200 displays the message “Ink has been depleted. Printing may not proceed until ink is supplied.” Consequently, the user can be notified that the ink inside the tank 32 has been depleted

When it is determined that the difference described above is greater than or equal to the predetermined value (S230: YES), it is assumed that the entire amount of ink in the bottle has been supplied into the tank 32 by the user. Accordingly, in the present embodiment, in S242 (see FIG. 13) the controller 50 corrects the count value of the supply counter 126 to the value A - B. In other words, the count value corresponding to the current estimated amount is corrected to match the value A-B. Therefore, errors due to individual variations that may actually be present even slightly in the dot count values of the ink described above can be corrected, and can increase the accuracy of subsequent detection of the residual amount.

According to the embodiment, the third threshold value of the amount of ink consumed is set to correspond to a case where it is predicted that the ink in the tank 32 has decreased and nearly been depleted, for example. When ink is consumed and the value of the amount of ink consumed reaches the third threshold value, in S260 (see FIG. 10) the printer 200 displays the message “Residual amount of ink is low. A new bottle can be ordered.” Accordingly, the user can be notified that the ink in the tank 32 is expected to nearly be depleted, and a bottle should be ordered.

According to the embodiment, when the difference described above is less than the predetermined value (S230: NO, see FIG. 10), it is assumed that the entire amount of ink in the bottle has not been supplied into the tank 32 by the user. In the present embodiment, in anticipation of the user subsequently supplying more ink from the bottle into the tank 32, the correction of the count value described above can be avoided by skipping S240.

In a case where an order for ink has already been placed, the dot count value of the supply counter 126 corresponding to the current estimated amount is to be initialized in preparation for fresh ink in the delivered bottle to be supplied into the tank 32. Accordingly, in the present embodiment, when the opening and closing of the openable cover 200B is detected by the open/close sensor 80 and the level of ink in the tank 32 becomes higher than the intermediate reference level ML, the controller 50 of the printer 200 executes S140 (see FIGS. 14 and 8). Additionally, when the printer 200 is started up upon power being turned ON, the printer 200 executes S140 (see FIGS. 7 and 8) when the level of ink in the tank 32 is above the intermediate reference level ML, and an order for ink has been placed. As a result, by the controller 50 in S140 subtracting the value A in FIG. 5 from the dot count, the initialization process accurately reflecting the residual amount of ink in the bottle before ink is supplied can reliably be performed.

In a case where the ink in the tank 32 is below the intermediate reference level ML while an order for ink has already been placed, ink would still remain in the existing bottle even though a new bottle will soon arrive. According to the embodiment, when the cover sensor detects the opening of the openable cover 200B in the above state, in S155 (see FIG. 8) the printer 200 displays the message “Please supply the entire amount of ink in the bottle.” Accordingly, supply of the remaining ink in the bottle to the tank 32 can reliably be requested to the user.

### Variations

The present invention is not limited to the embodiments described above, and may include various modifications and variations such as those described below:

For example, in the description above, an example is described in which the controller 50 of the printer 200 operates as an example of the residual amount management device by executing each of the steps shown in FIGS. 6 to 16; however, the information management server 100 may operate as an example of the residual amount management device by executing steps equivalent to those described above. In a case where the information management server 100 is to be operated as the residual amount management device, the display may be displayed on the display unit 301 of the mobile terminal 300 using a browser. Additionally, the mobile terminal 300 may operate as an example of the residual amount management device by executing steps equivalent to those described above. Furthermore, a single device may not operate as the residual amount management device, and instead a residual management system may be configured of multiple devices, such as the information management server 100, the printer 200, the mobile terminal 300, and other devices interacting with each other to execute each of the procedures shown in FIGS. 6 to 16 described above.

Moreover, in the above description, an example is described in which ink is used as an example of the printing consumable but is not limited to this configuration. For example, in a case where the printer 200 to be used is a laser printer instead of an inkjet printer, toner would be an example of the printing consumable.

Additionally, flowcharts illustrated in FIGS. 6 to 16 are not intended to limit the present disclosure to the steps shown, and steps may be added or deleted or the order of steps may be changed within the scope of the spirit and technical concept of the disclosure. In particular, although the above embodiment uses the supply counter 126 and the sensor counter 127, other counting methods may also be used. For example, the supply counter may be used without the sensor counter 127. Alternatively, down counting counters may be used, and the count values of the down counting counters decrease as ink is consumed.

Regarding the various components illustrated in the above embodiment and drawings, the numerical values, or the structure or chronological relationships of the various components may be modified and improved within the scope of technical concept.

In addition to what has already been described, the methods according to the embodiment and its variations described above may be used in suitable combinations.

The object of the present disclosure and the effects of the disclosure are not limited to those described above. That is, the present disclosure may resolve issues or achieve effects not described above, or may resolve some of the issues or achieve some of the effects described above.

In addition, although not illustrated individually, the present disclosure may be implemented with various modifications without departing from the scope of the disclosure.

The term “processor” encompasses both a single processor or a group of multiple processors located either locally or remotely working together or in a distributed fashion to collectively perform the tasks attributed to the “processor” described herein. One or more processors may be referred to as a “controller”.

Note that the present disclosure includes the phrases “at least one of A and B”, “at least one of A, B and C”, and the like as alternative expressions that mean one or more of A and B, one or more of A, B and C, and the like, respectively. More specifically, the phrase “at least one of A and B” means (A), (B) or (A and B), and the phrase “at least one of A, B and C” means (A), (B), (C), (A and B), (A and C), (B and C) or (A, B and C).

What is claimed is:

1. A residual amount management device for managing a residual amount of a printing consumable for a printing device, the printing device including: a tank configured to store the printing consumable supplied from a storage body having a predetermined capacity for storing a printing consumable; a level sensor configured to detect whether a level of the printing consumable in the tank is higher than or equal to an intermediate reference level, the intermediate reference level corresponding to an intermediate portion of the tank in a vertical direction; and a print engine configured to perform image formation on a printing medium by using the printing consumable in the tank,
the residual amount management device being configured to perform:
a printing amount obtaining process including:
obtaining printing-amount information indicating a printing amount of the printing consumable consumed by image formation using the print engine;
a first determining process in response to detection, by the level sensor, that the level of the printing consumable in the tank has increased from below the intermediate reference level to at or above the intermediate reference level, the first determining process including:
determining that the printing consumable is supplied into the tank from the storage body;
a second determining process in response to detection, by the level sensor, that after the first determining process, the level of the printing consumable in the tank becomes lower than the intermediate reference level during the image formation, the second determining process including:
determining whether a difference between a current estimated amount and a current detection amount is greater than or equal to a predetermined amount, the current estimated amount being calculated using the printing-amount information obtained in the printing amount obtaining process, the current estimated amount being calculated in response to determining that the printing consumable is supplied into the tank in the first determining process, the current detection amount being based on detection, by the level sensor, that the level of the printing consumable becomes lower than the intermediate reference level; and
a supply guidance process in a case where the difference is determined to be less than the predetermined amount in the second determining process, the supply guidance process including:
outputting supply-guidance information for guiding a supply of a printing consumable into the tank.

2. The residual amount management device according to claim 1, configured to further perform:
a supply-failure-case guidance process in a case where the difference is determined to be less than the predetermined amount in the second determining process, the supply-failure-case guidance process including:
outputting supply-failure-case guidance information corresponding to a case where a portion of the printing consumable fails to be supplied due to an error occurring while supplying the printing consumable into the tank.

3. The residual amount management device according to claim 1,
wherein in a case where the difference is determined to be less than the predetermined amount in the second determining process, the supply guidance process is repeatedly performed after the level of the printing consumable becomes lower than the intermediate reference level.

4. The residual amount management device according to claim 1, configured to further perform:
a first residual amount outputting process including:
outputting first residual amount information when a consumed amount of the printing consumable based on the obtained printing-amount information has reached a first threshold value after the level of the printing consumable becomes lower than the intermediate reference level, the first residual amount information indicating that a residual amount of the printing consumable in the tank is low.

5. The residual amount management device according to claim 1, configured to further perform:
a second residual amount outputting process in a case where the difference is determined to be greater than or equal to the predetermined amount in the second determining process, the second residual amount outputting process including:
outputting second residual amount information when a consumed amount of the printing consumable based on the obtained printing-amount information has reached a second threshold value, the second residual amount information indicating a residual amount of the printing consumable has been depleted.

6. The residual amount management device according to claim 1, configured to further perform:
a correction process in a case where the difference is determined to be greater than or equal to the predetermined amount in the second determining process, the correction process including:
correcting a count value corresponding to the current estimated amount into a count value corresponding to the current detection amount.

7. The residual amount management device according to claim 1, configured to further perform:
an order guidance outputting process including:
outputting order guidance information when a consumed amount of the printing consumable based on the obtained printing-amount information has reached a third threshold value, the order guidance information indicating guidance for placing an order for a printing consumable.

8. The residual amount management device according to claim 6,
wherein the residual amount management device does not perform the correction process in a case where the difference is determined to be less than the predetermined amount in the second determining process.

9. The residual amount management device according to claim 1,
wherein the printing device further includes an open/close sensor configured to detect opening and closing of an open/close portion, the open/close portion being configured to expose a supply port of the tank into which the printing consumable is supplied,
the residual amount management device being configured to further perform:
an initialization process in a case where opening of the open/close portion and closing of the open/close portion are detected, the level of the printing consumable in the tank becomes higher than or equal to the intermediate reference level, and an order for a printing consumable has been placed, the initialization process including:
initializing a count value corresponding to the current estimated amount based on an assumption that the amount of the printing consumable corresponding to the predetermined capacity has been supplied into the tank.

10. The residual amount management device according to claim 1, configured to further perform:
an initialization process in a case where the level of the printing consumable in the tank is higher than or equal to the intermediate reference level at startup by power-on, and an order for a printing consumable has been placed, the initialization process including:
initializing a count value corresponding to the current estimated amount based on an assumption that the amount of the printing consumable corresponding to the predetermined capacity has been supplied into the tank when power is off.

11. The residual amount management device according to claim 1,
wherein the printing device further includes an open/close sensor configured to detect opening and closing of an open/close portion, the open/close portion being configured to expose a supply port of the tank,
the residual amount management device being configured to further perform:
an entire-amount supply guidance process in a case where opening of the open/close portion is detected while the level of the printing consumable in the tank is below the intermediate reference level, and an order for a printing consumable has been placed, the entire-amount supply guidance process including:
outputting entire-amount supply guidance information for prompting a supply of an entire amount of a printing consumable in a storage body into the tank.
